(19) United States
(12) Patent Application Publication
(10) Pub. No.: US 2026/0006430 A1
(43) Pub. Date: Jan. 1, 2026

(54) SERVICE ENHANCEMENT PROVISIONING VIA APPLICATION PROGRAMMABLE INTERFACES IN WIRELESS COMMUNICATION NETWORKS

(71) Applicant: T-MOBILE INNOVATIONS LLC, Overland Park, KS (US)

(72) Inventors: Ravikumar Subramanian, Bothell, WA (US); Suresh Thanneeru, Bothell, WA (US); Swetha Gopisetti, Issaquah, WA (US); Suryanarayana Murthy Gorty, Redmond, WA (US); Chandrasekhar Darisi, Bothell, WA (US); Paria Hakimi, Franklin, TN (US); Poornima Magadevan, Renton, WA (US); Dharmik Devendra Mehta, Sammamish, WA (US)

(21) Appl. No.: 18/760,965

(22) Filed: Jul. 1, 2024

(51) Int. Cl. H04W 8/20; H04W 28/02; H04W 60/00

(52) U.S. Cl. CPC H04W 8/20; H04W 28/0268; H04W 60/00

(57) ABSTRACT

Various embodiments include a wireless communication network comprising a network service portal, a provisioning system, a control plane, and a user plane. The network service portal receives an API call from a development server comprising a service enhancement request. The network service portal identifies a slice to support the service enhancement. The provisioning system provisions a subscriber profile for the user device to authorize the device for service on the slice. The control plane receives a registration request from the user device, registers the user device for service on the communication network, accesses the subscriber profile of the device, selects the slice for the user device, and transfers a registration approval message that directs the device to use the slice. The user plane exchanges data with the device over the slice.

### TECHNICAL FIELD

Various embodiments of the present technology relate to wireless communication networks, and more specifically, to enabling application developers to request service enhancements for wireless user devices.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

Wireless communication networks implement network slicing to serve wireless user devices. A network slice is a type of network partition that groups a set of RAN and core network resources to provide a specific service. Network slices may be configured to provide low-latency services, media streaming services, Internet-of-Things (IoT) services, and the like. Exemplary slice types include Ultra-Reliable Low Latency Communication (URLLC), Enhanced Mobile Broadband (eMBB), and Massive Internet-of-Things (MIOT). By implementing network slicing, wireless communication networks optimize the computing and radio resources for specific service types thereby enhancing the overall user experience. However, not all user devices are subscribed for service on network slices tailored for the services the devices utilize. As a result, many users only partially experience the benefits of network slicing.

Unfortunately, in some instances, wireless communication networks may not efficiently tailor network slices to specific user applications. Moreover, some wireless communication networks may not always effectively enable third-party systems to request customized service for applications and user devices.

### Overview

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for wireless communications. Some embodiments comprise a method. The method comprises receiving, by a network service portal of a wireless communication network, an Application Programming Interface (API) call from a development server that comprises a service uplift request for a user device. The method further comprises identifying, by the network service portal, a wireless network slice to support the requested service uplift for the user device. The method further comprises provisioning, by a network provisioning system, a subscriber profile for the user device to authorize the user device for service on the wireless network slice. The method further comprises receiving, by a network control plane, a registration request from the user device, registering the user device for service on the wireless communication network, accessing the subscriber profile of the user device, selecting the wireless network slice for the user device, and transferring a registration approval message that directs the user device to use the wireless network slice. The method further comprises exchanging, by a network user plane, user data with the user device over the wireless network slice.

Some embodiments comprise a wireless communication network. The network comprises network service portal, a provisioning system, a control plane, and a user plane. The network service portal receives an API call from a development server that comprises a service uplift request for a user device. The network service portal identifies a wireless network slice to support the requested service uplift for the user device. The network provisioning system provisions a subscriber profile for the user device to authorize the user device for service on the wireless network slice. The network control plane receives a registration request from the user device and registers the user device for service on the wireless communication network. The network control plane accesses the subscriber profile of the user device and selects the wireless network slice for the user device. The network control plane transfers a registration approval message that directs the user device to use the wireless network slice. The network user plane exchanges user data with the user device over the wireless network slice.

Some embodiments comprise one or more non-transitory computer readable storage media having program instructions stored thereon. When executed by a computing system, the program instructions direct the computing system to perform operations. The operations comprise receiving an Application Programming Interface (API) call from a development server that comprises a service enhancement request for a user device. The operations further comprise identifying a wireless network slice to support the requested service enhancement for the user device. The operations further comprise provisioning a subscriber profile for the user device to authorize the user device for service on the wireless network slice. The operations further comprise receiving a registration request from the user device. The operations further comprise registering the user device for service on the wireless communication network. The operations further comprise accessing the subscriber profile of the user device. The operations further comprise selecting the wireless network slice for the user device. The operations further comprise transferring a registration approval message that directs the user device to use the wireless network slice. The operations further comprise exchanging user data with the user device over the wireless network slice.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates communication network.

FIG. 2 illustrates an exemplary operation of the communication network.

FIG. 3 illustrates a wireless communication network.

FIG. 4 illustrates an exemplary operation of the wireless communication network.

FIG. 5 illustrates an exemplary operation of the wireless communication network.

FIG. 6 illustrates a Fifth Generation (5G) communication network.

FIG. 7 illustrates a 5G User Equipment (UE) in the 5G communication network.

FIG. 8 illustrates a 5G Radio Access Network (RAN) in the 5G communication network.

FIG. 9 illustrates a Network Function Virtualization Infrastructure (NFVI) in the 5G communication network.

FIG. 10 further illustrates the NFVI in the 5G communication network.

FIG. 11 illustrates an exemplary operation of the 5G communication network.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

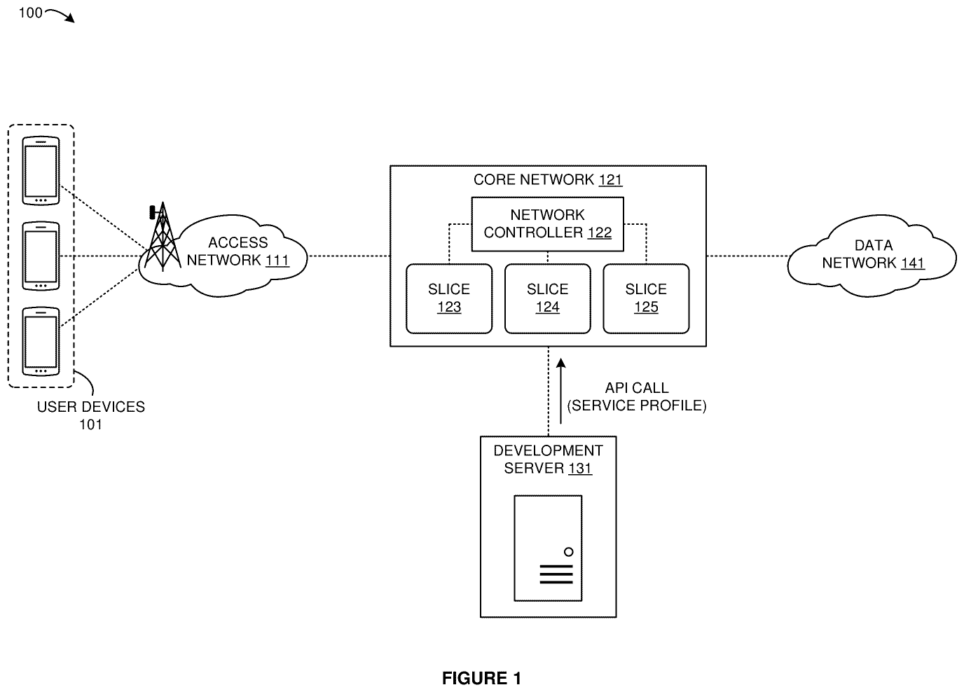

FIG. 1 illustrates communication network 100 to provide a service uplift to user devices. Communication network 100 delivers services like media-streaming, internet-access, voice/video calling, text messaging, machine communications, or some other wireless communications product. Communication network 100 comprises user devices 101, access network 111, core network 121, development server 131, and data network 141. Core network 121 comprises network controller 122 and network slices 123-125. In other examples, communication network 100 may comprise additional or different elements than those illustrated in FIG. 1.

Various examples of network operation and configuration are described herein. In some examples, development server 131 transfers an Application Programming Interface (API) call that includes a service profile to core network 121 to request a service uplift for one or more of user devices 101. The service profile indicates a service type and desired Quality-of-Service (QoS) level. Exemplary service types include video calling, media streaming, extended/virtual reality, online gaming, vehicle-to-everything (V2X), social networking, and the like. The service uplift is typically temporary, and the profile may indicate the duration and time period for when the uplift is to occur. For example, the service profile may request the uplift for a date range (e.g., from the dates April 29-April 30) and/or the service profile may request the uplift for a data range (e.g., uplift to a data cap of 1 gb). Network controller 122 receives the service profile from server 131 and identifies the service type and QoS level requested by server 131. Network controller 122 identifies one or more of network slices 123-125 to support the service uplift for the device. For example, the service type specified in the profile may comprise video calling and slice 123 may comprise a low-latency communication slice. In response, network controller 121 may correlate the service request to slice 123 based on the low latency capability to support video calling. Network controller 122 authorizes the user device to use the identified network slice (typically for a period of time and/or data cap specified in the profile). Once authorized, one of user devices 101 transfers a service request to core network 121 over access network 111. In response, network controller 122 assigns the user device to the slice selected to support the service uplift. The slice exchanges user data with the user device over access network 111 and with data network 141.

Communication network 100 provides wireless data services to user devices 101. Exemplary wireless data services include internet-access, media-streaming, social-networking, and machine-control. Exemplary wireless user devices comprise phones, computers, vehicles, robots, and sensors. Access network 111 comprises an example of a Radio Access Network (RAN). RANs exchange wireless signals with the wireless user devices over radio frequency bands. The wireless signals use wireless network protocols like Sixth Generation Radio (6GR), Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores like core network 121. The RANs are connected to the wireless network cores over backhaul data links. Access network 111 and core network 121 may communicate via edge networks like internet backbone providers, edge computing systems, or another type of edge system to provide the backhaul data links between node 111 and core network 121.

The RANs (e.g., access network 111) comprise Radio Units (RUs), Distributed Units (DUs) and Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to the network cores. The CUs handle higher wireless network layers like the Radio Resource Control (RRC), Service Data Adaption Protocol (SDAP), and Packet Data Convergence Protocol (PDCP). The CUs are coupled to network functions in core network 121.

Core network 121, development server 131, and data network 141 are representative of computing systems that provide wireless data services to user devices 101 over access network 111. Exemplary computing systems comprise Network Function Virtualization (NFVI) systems, provisioning virtualized infrastructures, data centers, server farms, cloud computing networks, hybrid cloud networks, and the like. The computing systems of core network 121 store and execute the network functions to form network controller 122 and network slices 123-125. Slices 123-125 provide wireless data services to user devices 101 over access network 111. Network controller 122 interfaces with development server 131 to assign user devices 101 to network slices 123-125 to perform service uplifts for devices 101 in response to service uplift requests received from server 131. Controller 122 and slices 123-125 may comprise network functions like Access and Mobility Management Function (AMF), Session Management Function (SMF), User Plane Function (UPF), Network Slice Selection Function (NSSF), Policy Control Function (PCF), Charging Function (CHF), Unified Data Management (UDM) Unified Data Registry (UDR), and the like. Core network 121 comprises a Third Generation Partnership Project (3GPP) network core architecture like Sixth Generation Core (6GC), Fifth Generation Core (5GC), Evolved Packet Core (EPC), and/or another type of 3GPP core network architecture. Development server 131 is representative of a computing system to create and update applications available for download by user devices 101 and transfer API calls to network core 121 to uplift service for devices 101. Data network 141 is representative of the communication endpoint for user devices 101. The computing systems of data network 141 comprise servers that host various application types (including applications developed by server 131) to serve user devices 101.

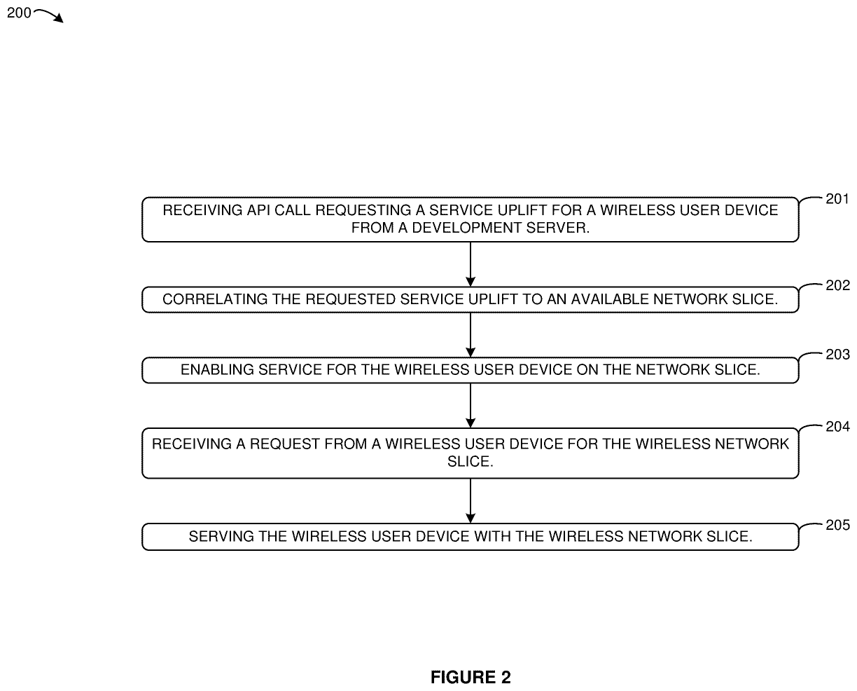

FIG. 2 illustrates process 200. Process 200 comprises an exemplary operation of communication network 100 to provide a service uplift to user devices. The operation may vary in other examples. The operations of process 200 comprise receiving an API call requesting a service uplift for a wireless user device from a development server (step 201). The operations further comprise correlating the requested service uplift to an available network slice (step 202). The operations further comprise enabling service for the wireless user device on the network slice (step 203). The operations further comprise receiving a request from a wireless user device for the wireless network slice (step 204). The operations further comprise serving the wireless user device with the wireless network slice (step 205).

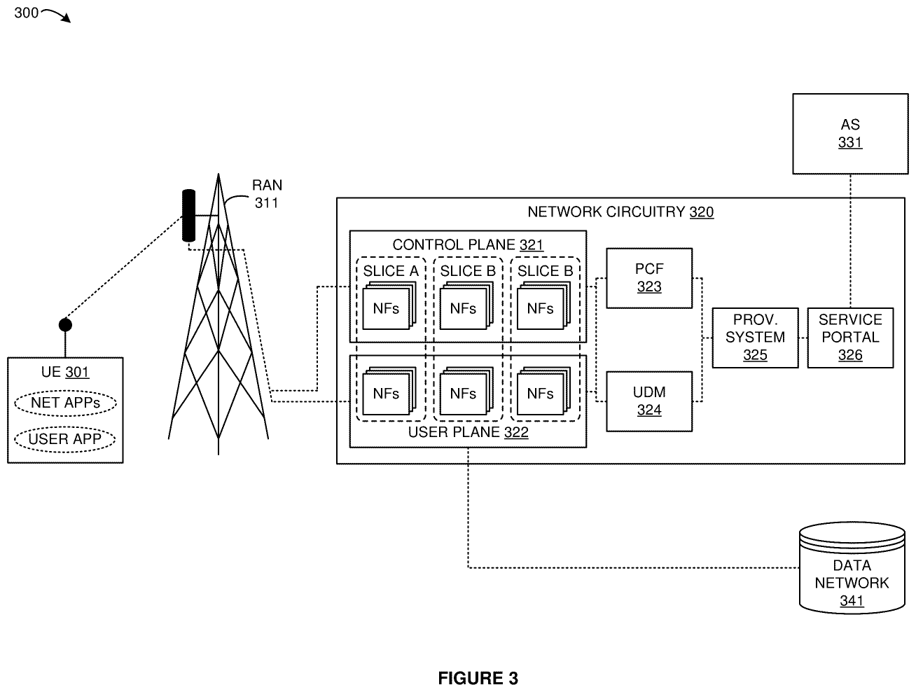

FIG. 3 illustrates wireless communication network 300 network to provide a service uplift to user devices. Wireless communication network 300 is an example of communication network 100, however network 100 may differ. Wireless communication network 300 comprises User Equipment (UE) 301, RAN 311, network circuitry 320, Application Server (AS) 331, and data network 341. Network circuitry 320 comprises control plane 321, user plane 322, PCF 323, UDM 324, provisioning (PROV.) system 325, and service portal 326. Control plane 321 comprises control plane network functions (NFs) and user plane 322 comprises user plane network functions. As illustrated in FIG. 3, the control plane and user plane network functions form network slice A, B, and C. In other examples, wireless network communication network 300 may comprise additional or different elements than those illustrated in FIG. 3.

In some examples, AS 331 is representative of an application development environment to create mobile applications available for wireless user devices (e.g., UE 301). AS 331 may generate mobile applications like media streaming applications, social media applications, low-latency applications, voice/video conferencing applications, online gaming applications, extended/virtual reality applications, and/or other types of mobile applications. UE 301 is associated with AS 331 and hosts a user application developed by AS 331. To tailor service on network 300 for the application hosted by UE 301, AS 331 transfers an API call to uplift service for UE 301 to service portal 326. The API call comprises a service profile that specifies a desired QoS, and a service type (e.g., for the application). Service portal 326 comprises an API and is representative of a network entity that interfaces with third party systems to enable temporary service uplifts for user devices. Service portal 326 receives the call and selects one of slices A, B, or C to support the desired QoS and service type requested by AS 331. For example, if the API call indicates the service type as extended reality, service portal 326 may correlate the extended reality service to a network slice with extended reality capabilities. Service portal 326 indicates the selected slice and requested QoS to provisioning system 325.

Network provisioning system 325 is representative of a network entity that loads network attributes and network policies to control plane 321 and user plane 322 to enable subscribed services for devices on network 300. Provisioning system 325 comprises entities like Network Provisioning Engine (NPE), Provisioning Gateway (PGW), Nokia Application Publisher (NAP), provisioning catalog, and the like. Network provisioning system 325 selects network attributes interpretable by control plane 321 and user plane 322 (e.g., Quality of Service Class Indicator (QCI) address value pairs) to enable the requested QoS and authorize UE 301 for service on the selected slice. Network provisioning system 325 may select additional/other attributes to uplift other service aspects of UE 301. For example, provision system 325 may select network attributes to specify maximum/minimum data rates, Guaranteed Data Rate (GBR) requirements, non-GBR requirements, maximum/minimum latency values, maximum/minimum throughput values, slice authorizations for specific devices/device types, slice authorizations for specific applications/application types running on UE 301, and/or other attributes to uplift the service of UE 301.

Provisioning system 325 transfers the network attributes to UDM 324 which loads the attributes onto the subscriber profile for UE 301. Provisioning system 325 also transfers network policies to PCF 323 that direct PCF 323 to route UE 301 to the selected network slice. Exemplary routing policies include UE Route Selection Policies (URSPs). UE 301 hosts network applications (NET APPs) and a user application associated with the AS 331. The network applications establish a signaling link with RAN 311 and transfer a service request to control plane 321 for service on network 300.

Control plane 321 is representative of the network functions that handle control signaling for registration, mobility, session setup, and the like for UE 301. Exemplary network functions include AMF, SMF, and the like. PCF 323 and UDM 324 are typically considered control plane functions, however they are illustrated as separate from control plane 321 for purposes of clarity. Control plane 321 interfaces with PCF 323 and UDM 324 to select a slice and establish a session for UE 301. UDM 324 returns service attributes enabling the QoS requested by AS 331 for UE 301 and that authorize UE 301 to use the selected slice. PCF 323 returns network policies that route UE 301 to the selected slice. Control plane 321 directs user plane 322 to serve UE 301 on the identified slice and at the QoS level based on the service attributes retrieved from UDM 324. Control plane 321 directs UE 301 to begin its session based on the slice based on the network policies retrieved from PCF 323. UE 301 exchanges user data with user plane 322 on the selected slice. User plane 322 is representative of the network functions that handle data exchange between UE 301, RAN 311, and data network 341. Exemplary user plane functions include UPF and the like. User plane 322 exchanges the user data with data network 341.

Advantageously, wireless communication network 300 efficiently tailors network slices to specific user applications. Moreover, wireless communication network 300 effectively enables third-party systems to request customized service for applications and user devices.

UE 301 and RAN 311 communicate over links using wireless/wired technologies like 6GR, 5GNR, LTE, LP-WAN, WIFI, Bluetooth, and/or some other type of wireless or wireline networking protocol. The wireless technologies use electromagnetic frequencies in the low-band, mid-band, high-band, or some other portion of the electromagnetic spectrum. The wired connections comprise metallic links, glass fibers, and/or some other type of wired interface. RAN 311, network circuitry 320, AS 331, and data network 341 communicate over various links that use metallic links, glass fibers, radio channels, or some other communication media. The links use 6GC, 5GC, EPC, IEEE 802.3 (ENET), Time Division Multiplex (TDM), Data Over Cable System Interface Specification (DOCSIS), Internet Protocol (IP), General Packet Radio Service Transfer Protocol (GTP), 5GNR, LTE, WIFI, virtual switching, inter-processor communication, bus interfaces, and/or some other data communication protocols.

UE 301 comprises a vehicle, drone, robot, computer, phone, sensor, or another type of data appliance with wireless and/or wireline communication circuitry. Although RAN 311 is illustrated as a tower, RAN 311 may comprise another type of mounting structure (e.g., a building), or no mounting structure at all. RAN 311 comprises a Fifth Generation (5G) RAN, LTE RAN, gNodeB, eNodeB, NB-IoT access node, trusted non-Third Generation Partnership Project (3GPP) access node, untrusted non-3GPP access node, LP-WAN base station, wireless relay, WIFI hotspot, Bluetooth access node, and/or another wireless or wireline network transceiver. UE 301 and RAN 311 comprise antennas, amplifiers, filters, modulation, analog/digital interfaces, microprocessors, software, memories, transceivers, bus circuitry, and the like. The control plane network functions comprise network functions like AMF, SMF, NSSF, NEF, AF, and the like. The user plane network functions comprise network functions like UPF and the like. AS 331 comprises an application development server to create applications available for download by UE 301 like media streaming applications, social media applications, low-latency applications, voice/video conferencing applications, online gaming applications, extended/virtual reality applications, and the like. Data network 341 comprises servers that host the applications developed by AS 431 like media streaming applications, social media applications, low-latency applications, voice/video conferencing applications, online gaming applications, extended/virtual reality applications, and the like.

UE 301, RAN 311, network circuitry 320, AS 331, and data network 341 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), and/or the like. The memories comprise Random Access Memory (RAM), flash circuitry, disk drives, and/or the like. The memories store software like operating systems, user applications, radio applications, and network functions. The microprocessors retrieve the software from the memories and execute the software to drive the operation of wireless communication network 300 as described herein.

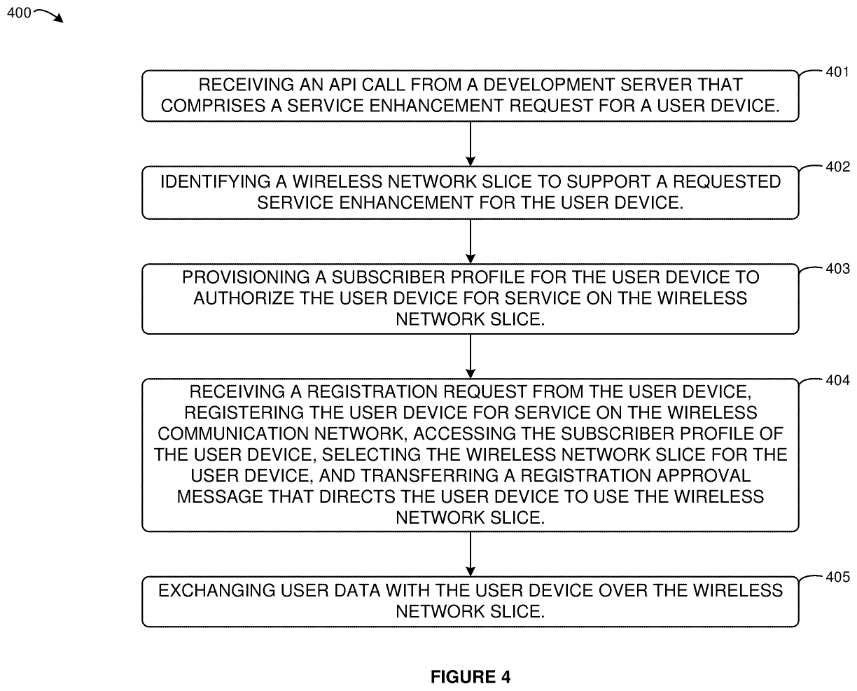

FIG. 4 illustrates process 400. Process 400 comprises an exemplary operation of communication network 300 to provide service uplifts for wireless UE. Process 400 comprises an example of process 200 illustrated in FIG. 2, however process 200 may differ. The operation may vary in other examples. The operations of process 400 comprise receiving an API call from a development server that comprises a service enhancement request for a user device (step 401). The operations further comprise identifying a wireless network slice to support a requested service enhancement for the user device (step 402). The operations further comprise provisioning a subscriber profile for the user device to authorize the user device for service on the wireless network slice (step 403). The operations further comprise receiving a registration request from the user device, registering the user device for service on the wireless communication network, accessing the subscriber profile of the user device, selecting the wireless network slice for the user device, and transferring a registration approval message that directs the user device to use the wireless network slice (step 404). The operations further comprise exchanging user data with the user device over the wireless network slice (step 405).

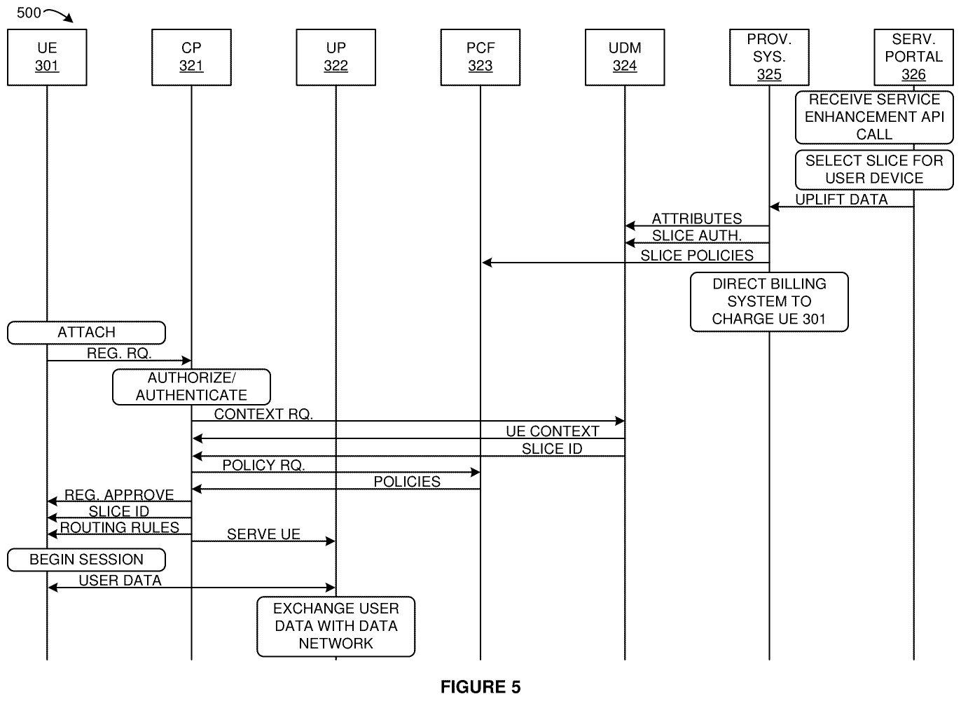

FIG. 5 illustrates process 500. Process 500 comprises an exemplary operation of wireless communication network 300 to provide service uplifts to wireless user devices. Process 500 comprises an example of process 200 and 400 illustrated in FIGS. 2 and 4, however process 200 and 400 may differ. The operation may vary in other examples. In some examples, AS 331 generates a video calling application and provisions the video calling application to UE 301. For example, UE 301 may be associated with the enterprise that operates AS 331 and UE 301 may download the application from AS 331 via a wireless connection. UE 301's subscription on network 300 is not optimized for the video calling application. For example, the video calling application may require minimum latency and throughput values that UE 301 is not subscribed to receive on network 300. As such, AS 331 generates an API call requesting a service uplift for UE 301 to tailor UE 301's service on the network to the application requirements. For example, the application may be in a beta/testing version and application developers may wish to test the application on UE 301 using network services optimized for the application. Alternatively, the application may be in a production version and the developers may simply wish to uplift the service to UE 301 in anticipation of a scheduled event (e.g., a video call).

AS 331 transfers the API call to service (SERV.) portal 326. The API call comprises a QoS profile, scope data, timing data, and charging data. The QoS profile indicates the requested QoS increase for UE 301, the service type (in this example video calling), and/or other requests like minimum uplink throughput, minimum downlink throughput, minimum latency, minimum jitter, and the like. The scope data indicates where in the network the uplift is to apply (e.g., to UE 301, to an application type(s) running on UE 301, to a specific application on UE 301, between endpoints like UE 301 and another device, etc.). The timing data indicates the duration of the uplift (e.g., permanent, scheduled, on-demand, up to a data cap, etc.). The charging data indicates the billing information for the uplift. AS 331 may organize the API call as a template with the service attributes that indicate the QoS profile, scope data, timing data, and billing data. Service portal 326 receives the API call from AS 331 and correlates the service type to one of network slices A-C. For example, service portal 326 may maintain a data structure that correlates Single Network Slice Selection Assistance Information (S-NSSAI) identifying available slices in network 300 (e.g., slices A-C) to requested service types (e.g., video calling, XR service, V2X service, etc.) and may select a slice to support the service uplift based on the output from the data structure. Service portal 326 indicates the selected slice (e.g., by S-NSSAI) as well as the uplift data included in the API call (e.g., QoS profile, scope data, timing data, and charging data) to provisioning system (PROV. SYS.) 325. In some examples, service portal 326 may forgo slice selection and instead direct provisioning system 325 to just uplift the QCI for UE 301 for a designated period of time/data amount (e.g., based on the API call) to perform the service uplift. For example, in LTE/EPC implementations where network slicing is unavailable, service portal 326 may interface with provisioning system 325 to temporarily increase a device's QCI based on a third-party API call to perform the service uplift for the device.

Provisioning system 325 translates the requested QoS, scope data, timing data, and charging data to network attributes to enable the service uplift for UE 301 on network 300. For example, provisioning system 325 may interface with a provisioning catalog to translate the requested QoS level into network attributes interpretable by the network functions in core 320 and network locations (e.g., UDM 324) for where the attributes should be provisioned. Provisioning system 325 selects address value pairs (e.g., network attributes) that define the QCI, authorized data rates, authorized throughputs, authorized latency, authorized jitter, and/or other types of network service for the uplift based on the QoS (or other requested services) from the API call. Provisioning system 325 selects address value pairs that authorize UE 301 to use the selected slice(s) based on slice indication (e.g., S-NSSAI) from service portal 326. Provisioning system 325 selects network policies (e.g., URSP rules) that route traffic exchanged by UE 301 within the scope/time of the uplift to the selected slice based on requested scope and timing data from the API call. Provisioning system 325 selects address value pairs that define a charging scheme to bill UE 301 for the service uplift based on the charging data from the API call.

Provisioning system 325 transfers a provisioning update to UDM 324 to load the subscriber profile of UE 301 with the service uplift address value pairs and the authorization to use the selected network slice. UDM 325 accesses the subscriber profile and loads the address value pairs and slice authorization to the profile. Provisioning system 325 transfers a provisioning update that includes data routing polices, timing policies, scope policies, and/or other network policies to PCF 323. When UE 301 attaches to the network, PCF 323 enforces the routing policies rules and scope policies to route traffic exchanged by UE 301 that is covered by the scope of the uplift to the selected slice. PCF 323 enforces the timing policies to enable the service uplift for the time period and/or up to the data cap requested by the API call. A network billing system (e.g., a CHF) charges UE 301 for the uplift based on the charging address value pairs provisioned by provisioning system 325.

Once the uplift is in place, UE 301 attaches to RAN 311 and transfers a registration request (REG. RQ.) to control plane (CP) 321. The registration request includes a session request for the video calling application associated with the service uplift requested by AS 331. Control plane 321 authenticates UE 301 and authorizes UE 301 for wireless data services. Control plane 321 transfers a context request to UDM 324. UDM 324 returns context data for UE 301 that includes the authorization for the slice selected for the service uplift and the network attributes defining the service for the uplift (e.g., QCI, throughput, latency, etc.). Control plane 321 transfers a network policy request to PCF 323 to create a policy association for UE 301. PCF 323 returns network policies that include the routing rules to route traffic covered by the uplift to the selected slice and timing rules to enable the uplift for the period of time and/or data cap. Control plane 321 selects the slice for UE 301 based on the slice authorization in the context. Control plane 321 transfers a registration approval message to UE 301, a slice Identifier (ID) (e.g., selected S-NSSAI) for the slice, and data routing rules to UE 301. The registration approval message directs UE 301 to begin it requested session on the network slice. Control plane 321 directs user plane (UP) 322 to serve UE 301 on the network slice for the service uplift.

UE 301 launches the video calling application to begin the session. The video calling application generates uplink data for the session. UE 301 wirelessly transfers the uplink data to the network functions in user plane 322 that form the selected network slice based on the URSP rules. The network functions transfer the uplink data to data network 341. Data network 341 generates downlink data for the video calling application and transfers the data to the network functions in user plane 322. The network functions deliver the downlink data to UE 301 over RAN 311.

Control plane 321 and/or PCF 323 monitor the session to track the progress of the service uplift. For example, control plane 321 and/or PCF 323 may track the data volume, time, or other data to determine if the uplift is still in effect. When control plane 321 and/or PCF 323 determine the uplift has ended (e.g., by expiration or a timer, date change, data limit reach, etc.), control plane 321 transfers a registration update message to UE 301 to terminate the uplift. Control plane 321 directs user plane 322 to stop exchanging user data for the session over the selected slice. UE 301 stops wirelessly transferring the uplink data to the network functions in user plane 322 that form the service uplift network slice based on the routing rules. The network functions that compose the selected slice stop delivering the downlink data to UE 301 over RAN 311. The billing system generates a charge for UE 301 based on UE 301's use of the network during the uplift and the billing data provisioned by system 325.

In some examples, service portal 326 may determine that the network does not currently host a network slice that corresponds to the service uplift requested by AS 331. In such examples, service portal 326 may interface with Management and Orchestration (MANO) to generate a new network slice to support the service uplift requested by AS 331. Service portal 326 may indicate the service type, requested QoS, and/or other network attributes to MANO. MANO (not illustrated) is representative of a network management entity that controls hardware use and instantiation of network functions in the control and user planes. MANO assigns computing resources for the new network slice and activates network functions in planes 321 and 322 for the slice. MANO transfers instantiation commands to control plane 321 and user plane 322 to instantiate the set of network functions. For example, MANO may instantiate an SMF and a UPF and provision the newly instantiated functions with capabilities to meet the QoS and service type selected by AS 331. A slice management entity in core 320 then generates the network slice (e.g., slice A) using the network functions activated by MANO. Once instantiated, provisioning system 325 delivers network attributes and polices to UDM 324 and PCF 323 to enable the service uplift on the newly instantiated network slice to enable the service uplift.

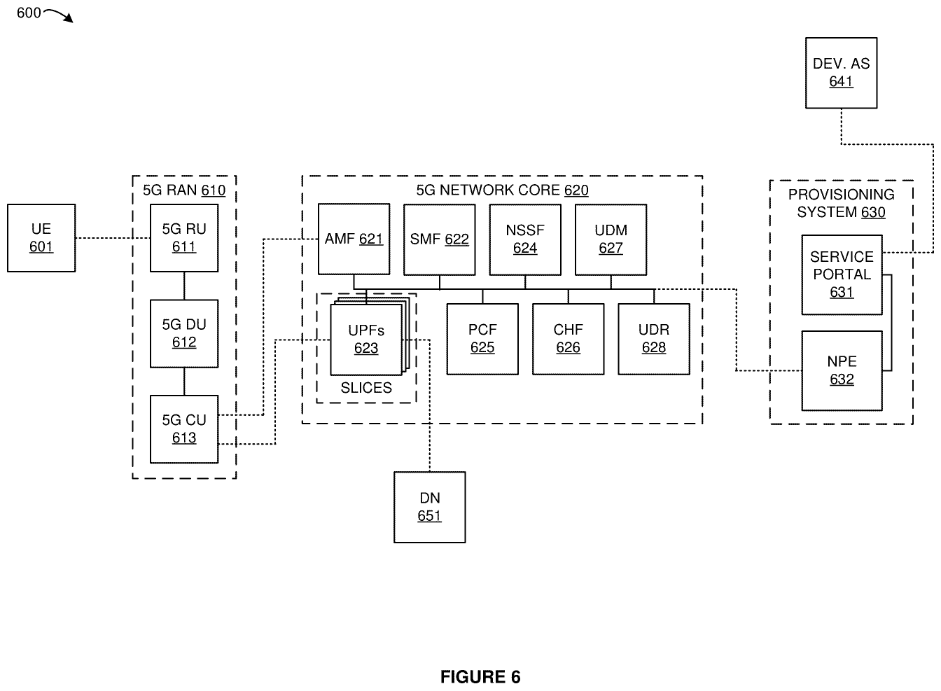

FIG. 6 illustrates 5G communication network 600 to provide service uplifts for wireless UE. 5G communication network 600 comprises an example of communication network 100 illustrated in FIG. 1 and wireless communication network 300 illustrated in FIG. 3, however networks 100 and 300 may differ. 5G Communication network 600 comprises 5G UE 601, 5G RAN 610, 5G network core 620, provisioning system 630, development (DEV.) AS 641, and data network 651. 5G RAN 610 comprises RU 611, DU 612, and CU 613. 5G network core 620 comprises AMF 621, SMF 622, UPFs 623, NSSF 624, PCF 625, CHF 626, UDM 627, and UDR 628. UPF 623s form a variety of network slices. Other network functions and network entities like Authenticating Server Function (AUSF), Network Exposure Function (NEF), Application Function (AF), Network Repository Function (NRF), Service Communication Proxy (SCP), and Equipment Identity Registry (EIR) are typically present in 5G network core 620 but are omitted for clarity. Provisioning system 630 comprises service portal 631 and NPE 632. Other provisioning functions and provisioning entities like PGW, NAP, and provisioning catalog are typically present in provisioning system 630 but are omitted for clarity. In other examples, 5G communication network 600 may comprise different or additional elements than those illustrated in FIG. 6.

In some examples, application development (DEV.) AS 641 creates a mobile application. The application may comprise a media streaming application, social media application, low-latency application, voice/video conferencing application, online gaming application, extended/virtual reality application, and the like. AS 641 provisions UE 601 with the application prior to attaching to network core 620. Alternatively, UE 601 may download the application created by AS 641 subsequent to attaching to core 620. Developers associated with AS 641 decide to request a service uplift for UE 601 to tailor service on network 600 to meet the requirements of the application (e.g., to test application performance using optimized network performance). In response to the uplift command from the operators, AS 641 transfers an API call to service portal 631 requesting a service uplift for UE 601. Service portal 631 returns a service uplift template that comprises service values that define the QoS, scope, timing, and billing for the uplift. The service template comprises default values that may be modified or otherwise filed out by AS 641 to customize the uplift for UE 601. For example, the template may include data entry windows, drop down menus, or other data entry options that allow AS 641 to modify the default values to define the uplift.

AS 641 receives the service template with default values from portal 631. AS 641 customizes some or all of the default QoS service values based on the requirements of the application. Exemplary QoS service values that may be selected by AS 641 include service type, QoS, latency, data rate, data throughput, location/geographic availability, and/or other metrics that define the requested QoS level for the uplift. For example, when the application comprises a video calling application (which are latency sensitive), AS 641 may select an enhanced QoS level and latency to optimize the performance of the video calling application while leaving the other QoS service values included in the template as defaults (e.g., default data rate). AS 641 selects scope service values to define where in the network the uplift will apply (e.g., to UE 601, an application on UE 601, etc.). Exemplary scope service values that may be selected by AS 641 include subscriber ID, device ID, endpoint IDs, group IDs, application type ID, application ID, credential requirements, and/or other values that define the scope of the uplift (e.g., where the uplift will apply). AS 641 selects timing service values to schedule the uplift for UE 601. Exemplary timing service values that may be selected by AS 641 include uplift duration, uplift schedule, uplift data cap, static indicators, on-demand indicators, dates, time windows, data caps, and/or other values that define when and how long the service uplift will apply. AS 641 selects billing service values to define how UE 601 will pay for the uplift. Exemplary billing service values that may be selected by AS 641 include charging rates and/or other data that defines how to charge UE 601 when the uplift is in effect. AS 641 generates and transfers an API call comprising the modified service uplift template to service portal 631.

A network API (e.g., a camara API) in service portal 631 receives the call from AS 641. Service portal 631 hosts a data structure that correlates the QoS service values included in the modified template received from AS 641 with network slices available in network core 620. As illustrated in FIG. 6, the network slices comprise UPFs 623. The slices may comprise Ultra-Reliable Low Latency Communications slices (URLLC), Enhanced Mobile Broadband (eMBB) slices, Massive Internet-of-Things (MIOT) slices, metaverse slices, media streaming slices, security slices, gaming slices, and the like. Service portal 631 inputs the QoS service values into the data structure which produces an output indicating the S-NSSAI for one of the slices in core 620. For example, the data structure may correlate service values for latency sensitive applications to URLLC slice, service values for XR applications to metaverse slices, service values for video streaming applications to media streaming slices, and the like. Although the slices are illustrated as comprising only UPFs 623, in other examples the slices may comprise additional network functions or RAN elements in network 600. For example, network core 620 may comprise multiple AMFs and SMFs and the slices may each comprise an AMF and an SMF in addition to UPFs 623. When the slices comprise multiple network functions, some of the network functions may be shared between the network slices. For example, two slices may each comprise SMF 622 while a third slice may comprise another SMF. It should be appreciated that the slices illustrated in FIG. 6 are exemplary and the slice configuration implemented by network core 620 may differ in other examples.

Network portal 631 transfers an uplift request to NPE 632 that comprises the S-NSSAI for the selected slice, the QoS service values, scope service values, the timing service values, and the billing service values selected by AS 641. For example, portal 631 may transfer Service Offering Codes (SOCs) that represent the S-NSSAI, the QoS values, scope values, timing values, and billing values to NPE 632. The uplift request directs NPE 632 to provision the network functions in core 620 to enable a temporary service boost to UE 601. NPE 632 interfaces with a provisioning catalog to translate the QoS, scope, timing, and billing service values into corresponding network attributes interpretable by the network functions in core 620 to enable the uplift. The network attributes typically comprise address value pairs and are loaded onto a subscriber profile of UE 601 to specify service to the UE. NPE 631 transfers provisioning commands to PCF 625, CHF 626, UDM 627, and UDR 628 that include the network attributes.

The provisioning command transferred to PCF 625 includes URSP rules, uplift timing policies, and uplift scope policies. The URSP rules route traffic covered by service uplift to the network slice selected by service portal 631, the uplift timing rules limit use of the network slice to a time window and/or data amount requested by AS 641, and the uplift scope policies permit traffic exchanged by devices/applications covered by the service uplift to access the slice while restricting other traffic (if any) exchanged by UE 601 from using the service uplift slice. The provisioning command transferred to CHF 626 comprises network polices that specify how to bill UE 601 when using the service uplift. The provisioning command transferred to UDM 627 comprises service attributes authorizing UE 601 to use the selected network slice during the time window requested by AS 641. The provisioning command transferred to UDR 628 comprises network attributes that uplift the service for UE 601 on the slice like temporarily enhanced QCI, latency, throughput, data rate, and/or other types of temporary service enhancements.

UE 601 wirelessly attaches to RAN 610. UE 601 launches the application generated by AS 641 and transfers a registration request to AMF 621 over RAN 610. The registration request includes information like registration type, UE capabilities, NSSAI requests, Protocol Data Unit (PDU) session requests, and the like. In response to the registration request, AMF 621 transfers an identity request to UE 601 over RAN 610. UE 601 indicates its identity to AMF 621 over RAN 610. Exemplary identity indications include Subscriber Concealed Identifier (SUCI) and the like. AMF 621 interacts with other network functions to authenticate the identity of UE 601 and authorize UE 601 for wireless data service. For example, AMF 621 may transfer an authentication request to an AUSF that includes the SUCI of UE 601. The AUSF may then interface with UDM 627 to retrieve authentication data to verify the SUCI of UE 601. The authentication data typically comprises the Subscriber Permanent Identifier (SUPI) for UE 601 and authentication vectors like an authentication challenge, key selection criteria, and a random number. The AUSF then transfers the authentication data and SUPI to AMF 621. AMF 621 may transfer an authentication challenge, key selection criteria, and random number to UE 601 over RAN 610. UE 601 may hash the random number using its copy of the secret key to generate an authentication response and transfer the response to AMF 621 over RAN 610. AMF 621 may authenticate UE 601 by matching the authentication response generated by UE 601 with the expected result.

Responsive to the authentication, AMF 621 registers UE 601 for service on network 600. AMF 621 selects UDM 627 and transfers a context get request to UDM 627 to retrieve data like access and mobility subscription data, supported network features, network slice selection data, SMF selection data, PDU session data, and the like. UDM 627 checks the timing data provisioned by NPE 632 to determine if the service uplift is active for UE 601. In response to determining the uplift is active, UDM 627 reads the service attributes for the uplift that were provisioned to UDR 628. UDM 628 returns an S-NSSAI authorizations for the uplift slice, QCI values, latency values, throughput values, data rate values, and/or other service attributes provisioned by NPE 632 to enable the uplift to AMF 621. AMF 621 receives the information and generates context for UE 601. AMF 621 selects and registers with PCF 625 to create a network policy association for UE 601. PCF 625 checks the timing data provisioned by NPE 632 to determine if the service uplift is active for UE 601. In response to determining the uplift is active, PCF 625 accesses the policies provisioned by NPE 632 for the service uplift and returns the URSP rule, the uplift timing rules, and the uplift scope policies to AMF 621.

Once the context is generated, AMF 621 selects NSSF 624 to select network slices for UE 601. AMF 621 transfers a get request to NSSF 624 to map the NSSAI requested by UE 601 to available network slices in network core 620. NSSF 624 receives the request and maps the NSSAI included in the get request to one or more of the network slices. In particular, NSSF 624 maps one of the S-NSSAI to the service uplift slice selected by portal 631. NSSF 624 returns the slice mappings to AMF 621 which then selects the service uplift slice as well as any other network slices requested by UE 601. For example, the slices may comprise the URLLC slice representing the service uplift slice, an eMBB slice, and a GBR network slice. UE 601 may include S-NSSAI for the service uplift URLLC slice, the eMBB slice, and the GBR slice in the initial registration request. NSSF 624 may interface with UDM 627 to determine if UE 601 is authorized for these slices. In response to determining UE 601 is authorized, NSSF 625 may map the S-NSSAIs in the get request to these slices to identify network slices for UE 601.

AMF 621 selects SMF 622 to serve UE 601 based on the selected network slices, UE context retrieved from UDM 627, network policies retrieved from PCF 625, and the like. AMF 621 directs SMF 622 to establish PDU sessions for UE 601 and indicates the S-NSSAIs for the selected network slices to SMF 622. SMF 622 selects corresponding ones of UPFs 623 to serve UE 601, included UPFs that form the service uplift slice. SMF 622 indicates the network addresses for the selected ones of UPFs 623 to AMF 621. AMF 621 includes the network addresses in the UE context and transfers the context and URSP rules to UE 601 over RAN 610. UE 601 uses the UE context to establish a PDU session for the application created by AS 641 over the application specific network slice. UE 601 exchanges user data with the corresponding one(s) of UPFs 623 over RAN 610 based on the URSP rules. The corresponding one(s) of UPFs 623 exchange the user data with data network 651. CHF 626 monitors the amount of use of the application specific network slice by UE 601 during the uplift. CHF 626 generates a monitory charge based on the billing rate provisioned by NPE 632 and the data amount/time of use and loads this charge to a subscriber profile for UE 601.

As UE 601 is provided uplifted service, AMF 621, SMF 622, PCF 625, and UDM 627 monitor the progress of the service uplift. In particular, these network functions determine when the time window for the uplift is over and/or when the data limit for the uplift has been reached. If either of these conditions are met, PCF 625 transfers a policy update command to AMF 621 to stop providing the uplifted service to UE 601 over the slice selected by service portal 631. UDM 627 removes UE 601's authorization for the uplift slice. SMF 622 directs UPFs 623 that compose the uplift slice to stop serving UE 601. AMF 621 transfers a registration update command to remove the UE 601's authorization to use the uplift slice. In response, UE 601 stops exchanging the user data for the uplifted service with the corresponding one(s) of UPFs 623 over RAN 610 that form the selected slice. The corresponding one(s) of UPFs 623 stop exchanging the user data with data network 651.

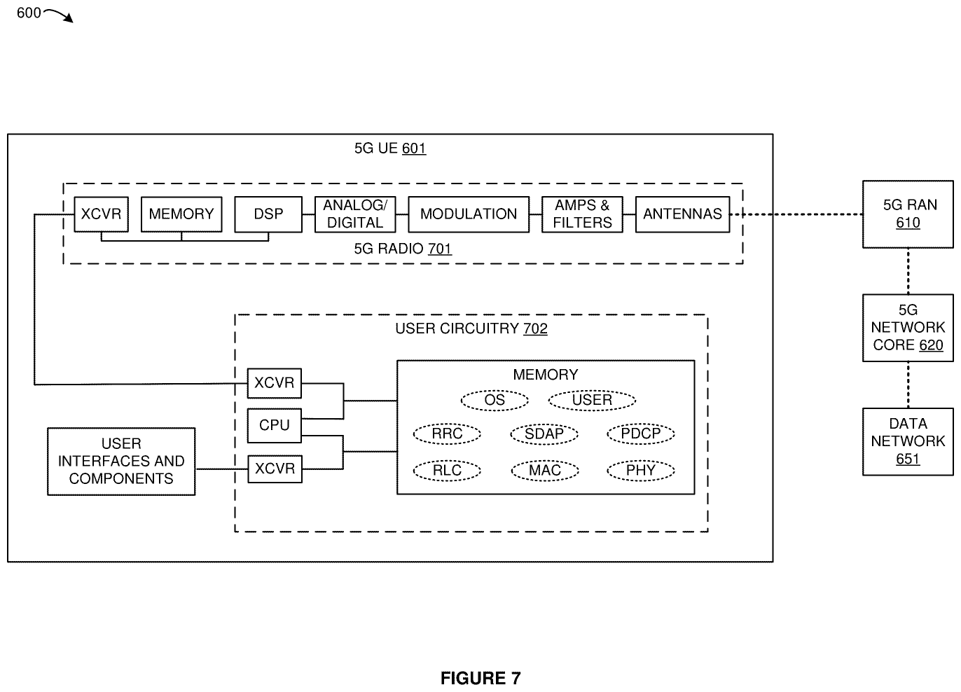

FIG. 7 illustrates 5G UE 601 in 5G communication network 600. UE 601 comprises an example of user devices 101 and UE 301, although user devices 101 and UE 301 may differ. UE 601 comprises 5G radio 701 and user circuitry 702. Radio 701 comprises antennas, amplifiers, filters, modulation, analog-to-digital interfaces, Digital Signal Processers (DSP), memory, and transceivers (XCVRs) that are coupled over bus circuitry. User circuitry 702 comprises memory, CPU, user interfaces and components, and transceivers that are coupled over bus circuitry. The memory in user circuitry 702 stores an operating system (OS), user applications (USER) and 5GNR network applications for Physical Layer (PHY), Media Access Control (MAC), Radio Link Control (RLC), Packet Data Convergence Protocol (PDCP), Service Data Adaptation Protocol (SDAP), and Radio Resource Control (RRC). The antenna in radio 701 is wirelessly coupled to 5G RAN 610 over a 5GNR link. A transceiver in radio 701 is coupled to a transceiver in user circuitry 702. A transceiver in user circuitry 702 is typically coupled to the user interfaces and components like displays, controllers, and memory.

In radio 701, the antennas receive wireless signals from 5G RAN 610 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 702 over the transceivers. In user circuitry 702, the CPU executes the network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data.

In radio 701, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to 5G RAN 610 that transport the uplink 5GNR signaling and data.

RRC functions comprise authentication, security, handover control, status reporting, QoS, network broadcasts and pages, and network selection. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. MAC functions comprise buffer status, power control, channel quality, Hybrid ARQ (HARQ), user identification, random access, user scheduling, and QoS. PHY functions comprise packet formation/deformation, windowing/de-windowing, guard-insertion/guard-deletion, parsing/de-parsing, control insertion/removal, interleaving/de-interleaving, Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs). The user application is representative of an application created by development AS 641 and associated with the service uplift network slice selected by service portal 631. The user application(s) may comprise a media streaming application, social media application, low-latency application, voice/video conferencing application, online gaming application, extended/virtual reality application, and the like.

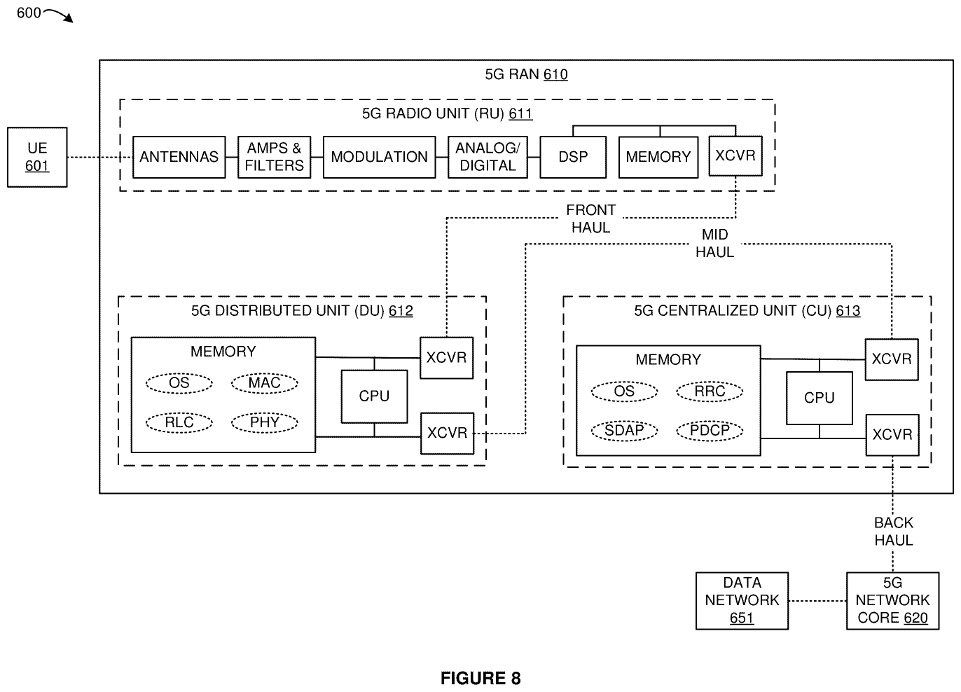

FIG. 8 illustrates 5G RU 611, 5G DU 612, and 5G CU 613 in 5G communication network 600. RU 611, DU 612, and CU 613 comprise an example of the access network 111 and RAN 311, although access network 111 and RAN 311 may differ. RU 611 comprises antennas, amplifiers, filters, modulation, analog-to-digital interfaces, DSP, memory, and transceivers (XCVRs) that are coupled over bus circuitry. UE 601 is wirelessly coupled to the antennas in RU 611 over 5GNR links. Transceivers in 5G RU 611 are coupled to transceivers in 5G DU 612 over fronthaul links like enhanced Common Public Radio Interface (eCPRI). The DSPs in RU 611 executes their operating systems and radio applications to exchange 5GNR signals with UE 601 and to exchange 5GNR data with DU 612.

For the uplink, the antennas receive wireless signals from UE 601 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to DU 612 over the transceivers.

For the downlink, the DSPs receive downlink 5GNR symbols from DU 612. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UE 601 that transport the downlink 5GNR signaling and data.

DU 612 comprises memory, CPU, and transceivers that are coupled over bus circuitry. The memory in 5G DU 612 stores operating systems and 5GNR network applications like PHY, MAC, and RLC. CU 613 comprises memory, CPU, and transceivers that are coupled over bus circuitry. The memory in CU 613 stores an operating system and 5GNR network applications like PDCP, SDAP, and RRC. Transceivers in 5G DU 612 are coupled to transceivers in RU 611 over front-haul links. Transceivers in DU 612 are coupled to transceivers in CU 613 over mid-haul links. A transceiver in CU 613 is coupled to network core 620 over backhaul links.

RLC functions comprise ARQ, sequence numbering and resequencing, segmentation and resegmentation. MAC functions comprise buffer status, power control, channel quality, HARQ, user identification, random access, user scheduling, and QoS. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/de-mapping, FFTs/IFFTs, and DFTs/IDFTs. PDCP functions include security ciphering, header compression and decompression, sequence numbering and re-sequencing, de-duplication. SDAP functions include QoS marking and flow control. RRC functions include authentication, security, handover control, status reporting, QoS, network broadcasts and pages, and network selection.

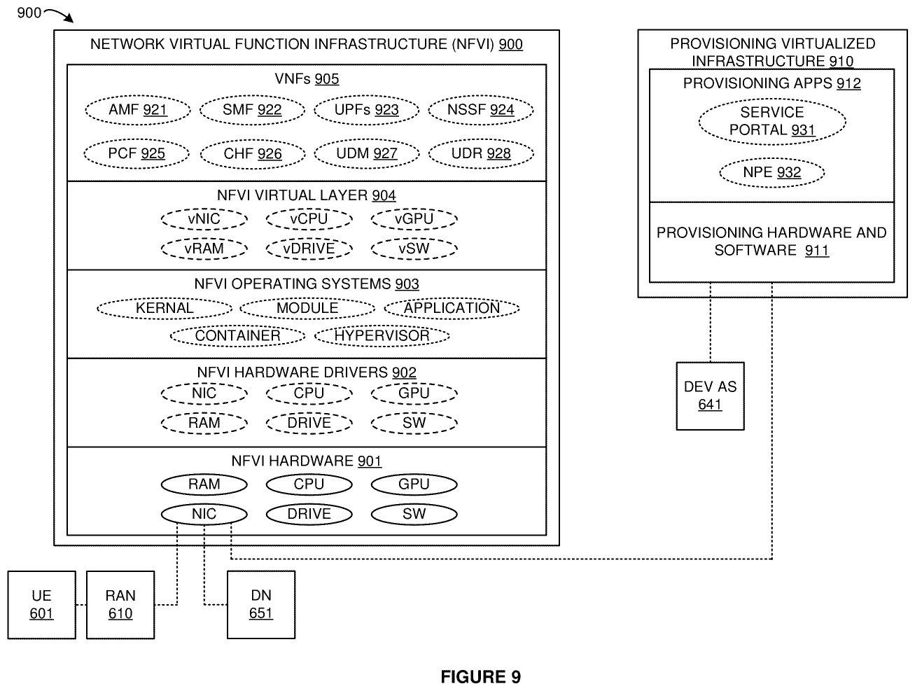

FIG. 9 illustrates Network Function Virtualization Infrastructure (NFVI) 900 and provisioning virtualized infrastructure 910 in 5G wireless communication network 600. NFVI 900 comprises an example of core network 121 illustrated in FIG. 1 and network circuitry 301 illustrated in FIG. 3, although core network 121 and network circuitry 301 may differ. Provisioning virtualized infrastructure 910 comprises an example of provisioning system 325 and service portal 326 illustrated in FIG. 3, however these systems may differ. NFVI 900 comprises NFVI hardware 901, NFVI hardware drivers 902, NFVI operating systems 903, NFVI virtual layer 904, and NFVI Virtual Network Functions (VNFs) 905. NFVI hardware 901 comprises Network Interface Cards (NICs), CPU, GPU, RAM, Flash/Disk Drives (DRIVE), and Data Switches (SW). NFVI hardware drivers 902 comprise software that is resident in the NIC, CPU, GPU, RAM, DRIVE, and SW. NFVI operating systems 903 comprise kernels, modules, applications, containers, hypervisors, and the like. NFVI virtual layer 904 comprises vNIC, vCPU, vGPU, vRAM, vDRIVE, and vSW. NFVI VNFs 905 comprise AMF 911, SMF 922, UPFs 923, NSSF 924, NSMF 925, CHF 926, NEF 927, and AF 928. Additional VNFs and network elements like AUSF, NEF, AF, NRF, SCP, and EIR are typically present but are omitted for clarity.

Provisioning virtualized infrastructure 910 comprises provisioning hardware and software 911 and provisioning applications (APPs) 912. Provisioning hardware and software 911 comprises provisioning hardware, provisioning hardware drivers, provisioning operating systems, and a provisioning virtual layer. The provisioning hardware comprises NICs, CPU, RAM, flash/disk drives, and data switches. The provisioning hardware drivers comprise software that is resident in the NIC, CPU, RAM, flash/disk drives, and data switches. The provisioning operating systems comprise kernels, modules, applications, containers, hypervisors, and the like. The provisioning virtual layer comprises vNIC, vCPU, vRAM, virtual flash/disk drives, and virtual data switches. Provisioning applications 912 comprise service portal 931 and NPE 932. Other provisioning applications like NAP and PGW are typically present but are omitted for clarity.

NFVI 900 and provisioning infrastructure 910 may be located at a single site or be distributed across multiple geographic locations. The NIC in NFVI hardware 901 is coupled to a NIC in provisioning hardware and software 911, to RAN 610, and to data network 951. The NIC in provisioning hardware and software 911 is coupled to the NIC in NFVI hardware 901 and to developer AS 941. NFVI hardware 901 executes NFVI hardware drivers 902, NFVI operating systems 903, NFVI virtual layer 904, and NFVI VNFs 905 to form AMF 611, SMF 622, UPFs 623, NSSF 624, PCF 625, CHF 626, UDM 627, and UDR 628. The hardware in provisioning hardware and software 911 executes the provisioning hardware drivers, provisioning operating systems, provisioning virtual layer, and provisioning applications 912 to form service portal 631 and NPE 632.

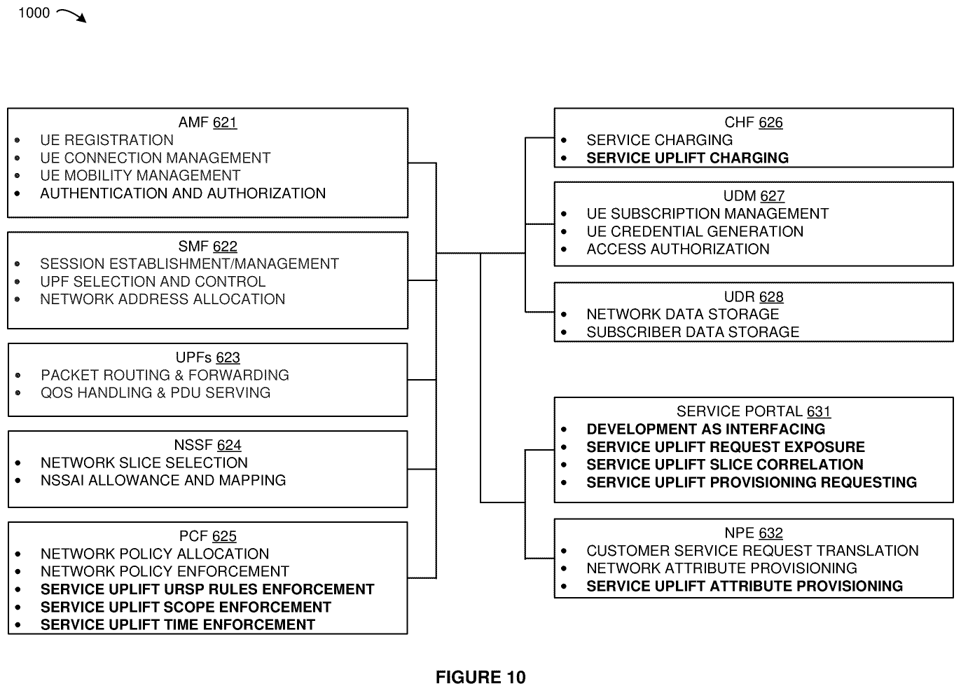

FIG. 10 further illustrates NFVI 900 in 5G communication network 600. AMF 621 comprises capabilities for UE registration, UE connection management, UE mobility management, and UE authentication and authorization. SMF 622 comprises capabilities for session establishment and management, UPF selection and control, and network address allocation. UPFs 623 comprise capabilities for packet routing, packet forwarding, QoS handling, and PDU serving. NSSF 624 comprises capabilities for network slice selection, NSSAI allowance, and NSSAI mapping. PCF 625 comprises capabilities for network policy allocation, network policy enforcement, service uplift URSP rules enforcement, service uplift scope enforcement, and service uplift time enforcement. CHF 626 comprises capabilities for service charging and uplift service charging. UDM 627 comprises capabilities for UE subscription management, UE credential generation, and access authorization. UDR 628 comprises capabilities for network and subscriber data storage. Service portal 631 comprises capabilities for development AS interfacing, service uplift request exposure, service uplift slice correlation, and service uplift provisioning requesting. NPE 632 comprises capabilities for customer service request translation, network attribute provisioning, and service uplift attribute provisioning.

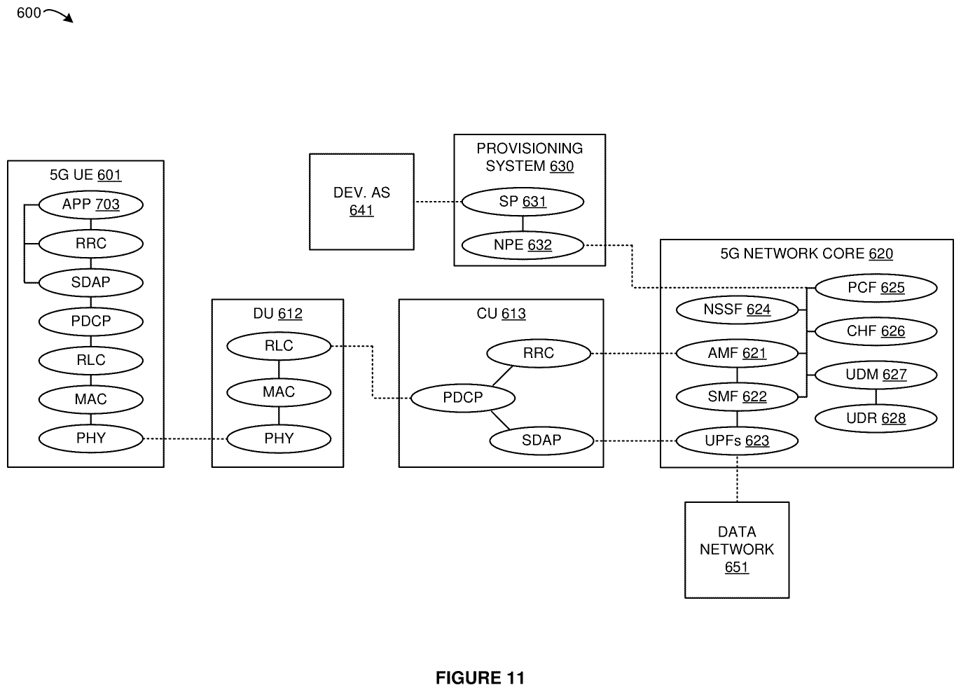

FIG. 11 illustrates an exemplary operation of 5G communication network 600 to provide service uplift for wireless UE. The operation may vary in other examples. In some examples, AS 641 creates an XR application. AS 641 provisions UE 601 with the XR application prior to attaching to network core 620. AS 641 requests a service uplift for UE 601 from portal 631 which returns a default uplift template. AS 641 modifies the default template values to select customized QoS, latency, data rate, data throughput, location/geographic availability, credential requirements, scope, timing, and charging information values to uplift service for communications related to the XR application on UE 601 for a 24-hour period. AS 641 transfers an API call to service portal (SP) 631 that comprises the service attribute template.

An API in service portal 631 receives the API call from AS 641. Portal 631 enters the service values from the template into its slice correlation data structure and responsively selects a metaverse slice to perform the uplift. Portal 631 transfers a provisioning request to NPE 632 provision the network functions in core 620 to enable the uplift. The request includes the SOCs representing the service values from the template, S-NSSAI for the XR slice, scope, and time window for the uplift. NPE 632 translates the received information into address value pairs and network policies interpretable by the network functions in core 620 to enable the elevated QoS for UE 601. NPE 632 transfers provisioning commands to PCF 625, CHF 626, UDM 627, and UDR 628 that include the address value pairs. PCF 625, CHF 626, UDM 627, and UDR 628 load the received address value pairs and network policies onto the subscriber profile for UE 601.

UE 601 launches the XR application and wirelessly attaches to CU 613 over DU 612 and RU 611. The RRC in UE 601 transfers a registration request to the RRC in CU 613 over the PDCPs, RLCs, MACs, and PHYs. The RRC in CU 613 forwards the request to AMF 621. The registration request indicates a registration type, UE capabilities, NSSAIs, and PDU session requests. In response to the registration request, AMF 621 transfers an identity request for UE 601 to the RRC in CU 613. The RRC forwards the identity request to the RRC in UE 601 over the PDCPs, RLCs, MACs, and PHYs. The RRC in UE 601 responds to the request by indicating its SUCI to the RRC in CU 613 over the PDCPs, RLCs, MACs, and PHYs. The RRC in CU 613 forwards UE 601's SUCI to AMF 621. AMF 621 interacts with other network functions to authenticate the identity of UE 601 and authorize UE 601 for wireless data service. Responsive to the authentication, AMF 621 registers UE 601 for service on network 600. AMF 621

Responsive to the authentication, AMF 621 registers UE 601 for service on network 600. AMF 621 requests context to serve UE 601 from UDM 627. UDM 627 accesses the subscriber profile for UE 601 stored on UDR 628 and retrieves service attributes for the uplift and service authorization for the XR slice. UDM 628 returns an S-NSSAI authorizations for the XR uplift slice and uplift service values to AMF 621. AMF 621 receives the information and generates context for UE 601. AMF 621 selects and registers with PCF 625 to create a network policy association for UE 601. PCF 625 returns the URSP rules to AMF 621 that direct UE 601 to route traffic exchanged by UE 601 for the XR application to the XR slice. Once the context is generated AMF 621, AMF 621 interfaces with NSSF 624 to select network slices for UE 601. NSSF 624 selects the S-NSSAI for the uplift slice and notifies AMF 621 of the slice selection. AMF 621 selects SMF 622 to serve UE 601 based on the selected network slice, UE context retrieved from UDM 627, network policies retrieved from PCF 625, and the like. AMF 621 directs SMF 622 to establish PDU sessions for UE 601 and indicates the S-NSSAIs for the selected network slices (included to the XR slice) to SMF 622. SMF 622 selects corresponding ones of UPFs 623 to serve UE 601. SMF 622 indicates the network addresses for the selected ones of UPFs 623 to AMF 621.

AMF 621 includes the network address, URSP rules, and S-NSSAI for the XR slice in the UE context and transfers the context to the RRC in CU 613. AMF 621 transfers the context to the RRC in CU 613. The RRC in CU 613 transfers the UE context to the RRC in UE 601 over the PDCPs, RLCs, MACs, and PHYs. The RRC in UE 601 uses the UE context to establish the PDU session for the XR application. The RRC directs the SDAP in UE 601 to begin the PDU session. The XR application generates user data for the PDU session. The SDAP exchanges user data with the SDAP in CU 613 over the PDCPs, RLCs, MACs, and PHYs based on the URSP rules. The SDAP in CU 613 exchanges the user data with the one of UPFs 623 that forms the XR slice. The one of UPFs 623 that forms the XR slice exchanges the user data with data network 651. CHF 626 monitors the amount of use of the XR slice by UE 601. CHF 626 generates a monitory charge for UE 601 based on the amount of use and loads this charge to a subscriber profile for UE 601.

As UE 601 is provided uplifted service, AMF 621, SMF 622, PCF 625, and UDM 627 monitor the progress of the service uplift. SMF 622 determines UE 601 has reached the data limit for the uplift notifies PCF 625 and UDM 627. PCF 625 transfers a policy update command to AMF 621 to stop providing the uplifted service to UE 601 over the XR slice. UDM 627 removes UE 601's authorization for the XR slice. SMF 622 directs the UPFs that form the XR slice to stop serving UE 601. AMF 621 transfers a registration update command to remove UE 601's authorization to use the uplift slice to the RRC in CU 613. The RRC in CU 613 forwards the registration update to the RRC in UE 601 over the PDCPs, RLCs, MACs, and PHYs. In response, UE 601 stops exchanging the user data for the uplifted service with the corresponding one(s) of UPFs 623 over RAN 610 that form the selected slice. The corresponding one(s) of UPFs 623 stop exchanging the user data with data network 651.

The wireless data network circuitry described above comprises computer hardware and software that form special-purpose network circuitry to provide uplifted service to user devices. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to provide uplifted service to user devices.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method comprising:
in a wireless communication network, a network service portal receiving an Application Programming Interface (API) call from a development server that comprises a service uplift request for a user device;
the network service portal identifying a wireless network slice to support the requested service uplift for the user device;
a network provisioning system provisioning a subscriber profile for the user device to authorize the user device for service on the wireless network slice;
a network control plane receiving a registration request from the user device, registering the user device for service on the wireless communication network, accessing the subscriber profile of the user device, selecting the wireless network slice for the user device, and transferring a registration approval message that directs the user device to use the wireless network slice; and
a network user plane exchanging user data with the user device over the wireless network slice.

2. The method of claim 1 wherein:
the service enhancement request indicates a requested Quality-of-Service (QOS) and a service type for the user device;
the service enhancement request indicates a scope that defines where the service enhancement is enforced;
the scope comprises at least one of services associated with the user device, services associated with an application type executing on the user device, or services associated with a specific application executing on the user device;
the service enhancement request indicates a time period that defines when the service enhancement is enforced; and
the service enhancement request comprises charging data that defines a billing rate for the service enhancement.

3. The method of claim 2 wherein the network service portal identifying the wireless network slice to support the requested service enhancement comprises correlating the service type specified by the request to the wireless network slice.

4. The method of claim 2 wherein:
the network provisioning system provisioning the subscriber profile for the user device comprises loading the subscriber profile stored by a network data system with network service attributes; and
the network service attributes authorize the user device for a Single-Network Slice Selection Assistance Information (S-NSSAI) for the network slice, indicate a Quality-of-Service Class Indicator (QCI) for the requested service enhancement on the network slice, define the time period for the service enhancement, and define the billing rate for the service enhancement.

5. The method of claim 4 further comprising a charging function generating a bill based on the billing rate and an amount of user data exchanged with the user device over the wireless network slice.

6. The method of claim 1 wherein the network control plane transferring the registration approval message that directs the user device to use the wireless network slice comprises transferring User Equipment Route Selection Policy (URSP) rules that direct the user device to user the wireless network slice.

7. The method of claim 1 wherein the wireless network slice comprises at least one of an Ultra Reliable Low Latency Communications (URLLC) slice, an Enhanced Mobile Broadband (eMBB) slice, a Massive Internet-of-Things (MIOT) slice, an Extended Reality (XR) slice, a video streaming slice, an online gaming slice, a video calling slice, a Guaranteed Bit Rate (GBR) slice, a non-GBR slice, or a Vehicle-to-Everything (V2X) slice.

8. A wireless communication network comprising:
a network service portal to receive an Application Programming Interface (API) call from a development server that comprises a service uplift request for a user device;
the network service portal to identify a wireless network slice to support the requested service uplift for the user device;
a network provisioning system to provision a subscriber profile for the user device to authorize the user device for service on the wireless network slice;
a network control plane to receive a registration request from the user device, register the user device for service on the wireless communication network, access the subscriber profile of the user device, select the wireless network slice for the user device, and transfer a registration approval message that directs the user device to use the wireless network slice; and
a network user plane to exchange user data with the user device over the wireless network slice.

9. The wireless communication network of claim 8 wherein:
the service enhancement request indicates a requested Quality-of-Service (QOS) and a service type for the user device;
the service enhancement request indicates a scope that defines where the service enhancement is enforced;
the scope comprises at least one of services associated with the user device, services associated with an application type executing on the user device, or services associated with a specific application executing on the user device;
the service enhancement request indicates a time period that defines when the service enhancement is enforced; and
the service enhancement request comprises charging data that defines a billing rate for the service enhancement.

10. The wireless communication network of claim 9 wherein the network service portal is to correlate the service type specified by the request to the wireless network slice.

11. The wireless communication network of claim 9 wherein:
the network provisioning system is to load the subscriber profile stored by a network data system with network service attributes; and
the network service attributes authorize the user device for a Single-Network Slice Selection Assistance Information (S-NSSAI) for the network slice, indicate a Quality-of-Service Class Indicator (QCI) for the requested service enhancement on the network slice, define the time period for the service enhancement, and define the billing rate for the service enhancement.

12. The wireless communication network of claim 11 further comprising a charging function to generate a bill based on the billing rate and an amount of user data exchanged with the user device over the wireless network slice.

13. The wireless communication network of claim 8 wherein the network control plane is to transfer User Equipment Route Selection Policy (URSP) rules that direct the user device to user the wireless network slice.

14. The wireless communication network of claim 8 wherein the wireless network slice comprises at least one of an Ultra Reliable Low Latency Communications (URLLC) slice, an Enhanced Mobile Broadband (eMBB) slice, a Massive Internet-of-Things (MIOT) slice, an Extended Reality (XR) slice, a video streaming slice, an online gaming slice, a video calling slice, a Guaranteed Bit Rate (GBR) slice, a non-GBR slice, or a Vehicle-to-Everything (V2X) slice.

15. One or more non-transitory computer readable storage media having program instructions stored thereon, wherein the program instructions, when executed by a computing system, direct the computing system to perform operations, the operations comprising:
receiving an Application Programming Interface (API) call from a development server that comprises a service enhancement request for a user device;
identifying a wireless network slice to support the requested service enhancement for the user device;
provisioning a subscriber profile for the user device to authorize the user device for service on the wireless network slice;
receiving a registration request from the user device;
registering the user device for service on the wireless communication network;
accessing the subscriber profile of the user device;
selecting the wireless network slice for the user device;
transferring a registration approval message that directs the user device to use the wireless network slice; and
exchanging user data with the user device over the wireless network slice.

16. The computer readable storage media of claim 15 wherein:
the service enhancement request indicates a requested Quality-of-Service (QOS) and a service type for the user device;
the service enhancement request indicates a scope that defines where the service enhancement is enforced;
the scope comprises at least one of services associated with the user device, services associated with an application type executing on the user device, or services associated with a specific application executing on the user device;
the service enhancement request defines a time period that defines when the service enhancement is enforced; and
the service enhancement request comprises charging data that defines a billing rate for the service enhancement.

17. The computer readable storage media of claim 16 wherein identifying the wireless network slice to support the requested service enhancement comprises correlating the service type specified by the request to the wireless network slice.

18. The computer readable storage media of claim 16 wherein:
provisioning the subscriber profile for the user device comprises loading the subscriber profile stored by a network data system with network service attributes; and
the network service attributes authorize the user device for a Single-Network Slice Selection Assistance Information (S-NSSAI) for the network slice based on the scope, define a Quality-of-Service Class Indicator (QCI) for the requested service enhancement on the network slice based on the requested QoS, define the time period for the service enhancement, and define the billing rate for the service enhancement.

19. The computer readable storage media of claim 15, the operations further comprising generating a bill based on the billing rate and an amount of user data exchanged with the user device over the wireless network slice.

20. The computer readable storage media of claim 15 wherein transferring the registration approval message that directs the user device to use the wireless network slice comprises transferring User Equipment Route Selection Policy (URSP) rules that direct the user device to user the wireless network slice.
